(19) United States
(12) Patent Application Publication
(10) Pub. No.: US 2004/0220848 A1
(43) Pub. Date: Nov. 4, 2004

(54) System and method for managing requests for services

(76) Inventor: Jeffrey P. Leventhal, Boca Raton, FL (US)

Correspondence Address: GREENBERG TRAURIG, LLP, 77 WEST WACKER DRIVE, SUITE 2500, CHICAGO, IL, 60601-1732, US

(21) Appl. No.: 10/755,569

(22) Filed: Jan. 12, 2004

Related U.S. Application Data
(63) Continuation-in-part of application No. 10/692,194, filed on Oct. 23, 2003.
(60) Provisional application No. 60/465,977, filed on Apr. 28, 2003.

(51) Int. Cl. G06F 17/60

(52) U.S. Cl. 705/9; 705/1; 705/40

(57) ABSTRACT

A system and method for managing requests for services, in particular via the use of the Internet. The system maintains a information concerning capabilities and availabilities of a plurality of service providers such as repair technicians, temporary employees, in-home health care providers (e.g., nurses), and the like, which information is viewable by service requestors. In response to the receipt of a service request from a service requester, a work order is created and routed to one or more of the service providers for the purpose of having one or more of the selected service providers indicate an acceptance of the work order. The service providers may be automatically selected using the information maintained within the system or may be manually selected, for example, by the service requester.

### RELATED APPLICATION

This application is a continuation-in-part of U.S. application Ser. No. 10/692,194, filed Oct. 23, 2003 which, in turn, claims the benefit of U.S. Provisional Patent Application Serial No. 60/465,977 filed Apr. 28, 2003 which applications are incorporated herein by reference in their entirety.

### BACKGROUND

The subject invention relates generally to a system and method for managing requests for services.

A need presently exists for an improved system and method for requesting, deploying, managing, and delivering services. This need is especially felt by relatively medium to larger sized companies with multiple geographic locations and complex multi-vendor environments. By way of example only, considering service requests directed to computer, computer peripheral, and/or computer network repair, while many such companies do have full-time IT support staffs in their larger offices (e.g., 50 employees or more), smaller branch offices, which use the same technology and systems as their larger counter-part offices, typically lack full-time, on-site IT assistance. In this regard, employing full-time, on-site IT personnel at such locations is generally not feasible given the associated costs. As such, to have their computer service needs fulfilled, these smaller branch offices must rely on support from a centralized help desk, engage local IT companies/consultants, and/or contract with a computer service firm that claims to have national coverage.

In instances where a branch office relies on assistance from a corporate help desk to address their computer service needs, technology is presently available that allows a service provider to remotely access a computer for the purpose of attempting to solve certain problems that may exist. However, not all problems are capable of being solved in this manner, e.g., problems associated with computers that are not capable of being turned on, printers that are jammed, cables that are broken, etc. Thus, to meet branch office demands for computer services arising from problems that cannot be serviced via the use of remote access software, the only alternative left for a centralized help desk is to request that the equipment experiencing the problem be sent out for repair or to send a technician to the branch office to solve the problem. Undesirably, performing repair services in this manner is inefficient and costly, especially when the service request results from a problem that is relatively minor. Furthermore, there exists a cost that is associated with the time of lost access to the equipment in that employees at the branch office may not be capable of performing their required work without the operable equipment.

When branch or remote offices are authorized to engage local companies for the purpose of addressing their computer service needs, other problems tend to arise. In this regard, problems may be created for the help desk as they attempt to manage the arrangement of services throughout the entirety of a company at all of the different locations. Further problems arise from the need to budget and manage the costs associated with requesting services in this manner. By way of example, if a company has three hundred locations, that may equate to three hundred computer service vendors, with three hundred different prices for parts and hourly service rates, with three hundred different response times, etc. Thus, for companies having multiple geographic locations and complex multi-vendor computer environments, the problems associated with contracting service professionals, e.g., coordinating accounting, paying large quantities of small invoices, etc., can become very burdensome.

To address some of these problems, a company can contract with a large service provider company, for example, IBM, EDS or CSC. However, while large service providers can deploy services that are generally consistent around the country and the contracting company would have only one vendor with one price for parts and labor, these contracts are usually limited in scope and extremely costly. In this regard, service contracts usually cover only hardware and act like extended warranties. Thus, if a company requests services in an area that falls into a category not covered under contract, the hourly rates can become exorbitantly high. In addition, the most comprehensive on-site contracts still leave open ends for equipment covered under warranty, software problems, new system roll-outs and other upgrades. Still further, large service providers often utilize the services of sub-contractors which makes it increasingly difficult if not impossible for service requestors to track the progress of service requests. To further complicate matters, large service providers often try to protect or mask their use of sub-contractors so as to give the appearance of providing a comprehensive service solution.

### SUMMARY

For use in providing an improved system and method for managing service requests, described hereinafter is a system and method capable of controlling, building, and deploying a scalable workforce to solve service related problems quickly and efficiently. More particularly, the subject system and method allows any business to create and manage a service department. In a described system, the creation and management of the service department is conveniently performed via the Internet. The subject system may also be used by a service requestor to monitor and pay for services. To this end, the subject system maintains information concerning capabilities and availabilities (e.g., geographic and/or time) of a plurality of service providers which information is viewable by service requesters. In response to the receipt of a service request from a service requestor, a work order is created and routed to one or more of the service providers for the purpose of having one or more of the selected service providers indicate an acceptance of the work order. The service providers may be automatically selected using the information maintained within the system (as a function of the requirements set forth in the service request) or may be manually selected, for example, by the service requestor. Payment may be made to the selected service provider using a fund associated with the service requester and managed by the system.

A better understanding of the objects, advantages, features, properties and relationships of the subject system and method will be obtained from the following detailed description and accompanying drawings which set forth illustrative embodiments which are indicative of the various ways in which the principles of the system and method may be employed.

### BRIEF DESCRIPTION OF THE DRAWINGS

For a better understanding of the system and method for managing service requests, reference may be had to preferred embodiments shown in the following drawings in which:

FIG. 1 illustrates a block diagram of an exemplary computer system in which the principles of the subject invention may be employed;

FIG. 2 illustrates a flow chart diagram of an exemplary method for managing service requests;

FIG. 3 illustrates a process flow diagram of an exemplary method for managing service requests;

FIG. 4 illustrates a further process flow diagram of the exemplary method for managing service requests with a particular focus on the service requestor;

FIG. 5 illustrates a further process flow diagram of the exemplary method for managing service requests with a particular focus on the service provider;

FIGS. 6-8 illustrate exemplary screen shots of Web pages by which a client service provider may register with the subject system;

FIG. 9 illustrates an exemplary screen shot of a Web page by which a service requestor may indicate a desire to have a service request fulfilled;

FIG. 10 illustrates an exemplary screen shot of a Web page for use in managing a service provider on-line office; and

FIG. 11 illustrates an exemplary screen shot of a service provider rating.

### DETAILED DESCRIPTION

Turning to the drawings, wherein like reference numerals refer to like elements, an exemplary system and method for managing service requests is illustrated and described. Although not required, the system and method will be described in the general context of computer executable instructions being executed by one or more processing devices such as a personal computer, mainframe computer, personal-digital assistant (“PDA”), cellular telephone, or the like. Generally, the computer executable instructions reside in program modules which may include routines, programs, objects, components, data structures, etc. that perform particular tasks or implement particular abstract data types. In this regard, those skilled in the art will appreciate that the system and method described hereinafter may also be practiced in distributed computing environments where tasks are performed by various processing devices that are linked through a communication network and where program modules may be located in both local and remote memory storage devices associated with such processing devices.

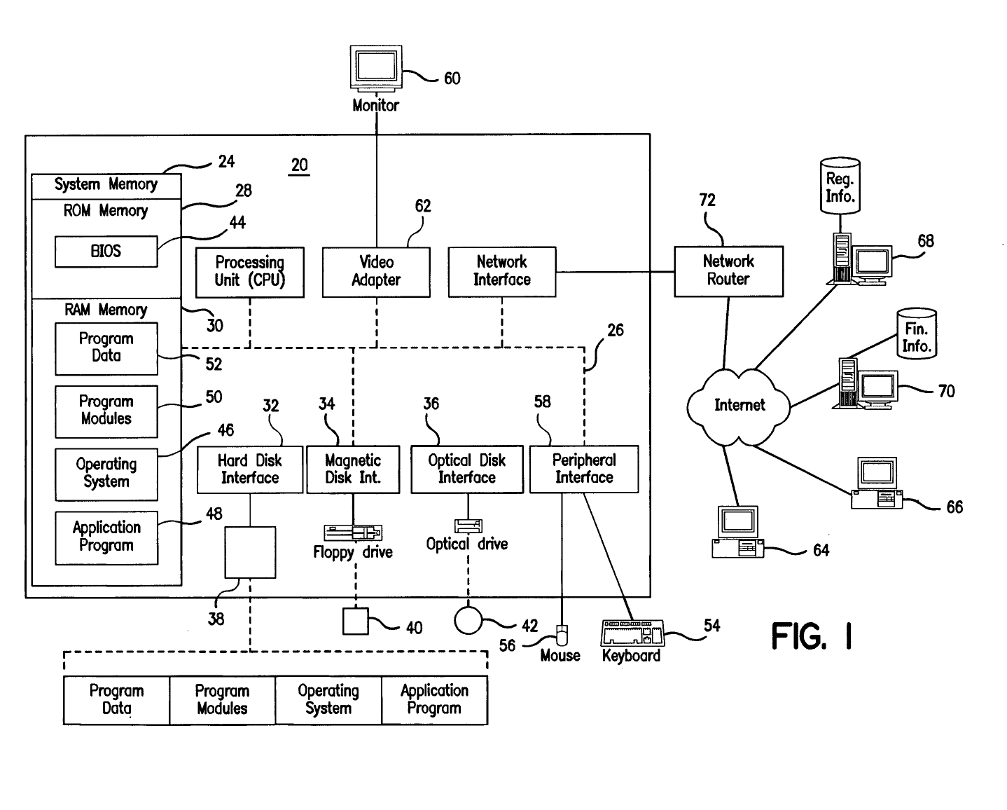

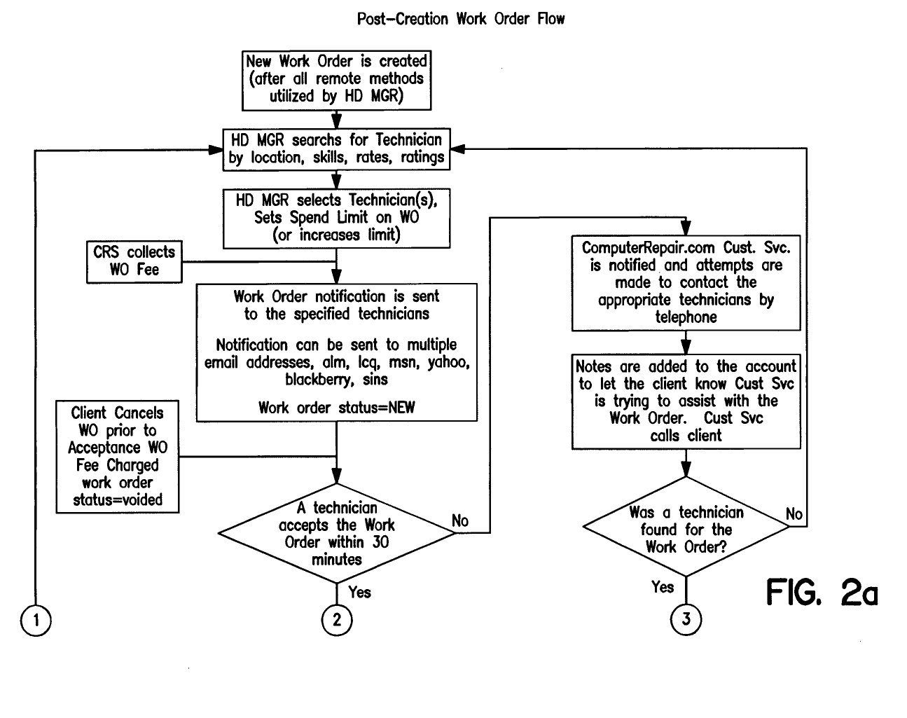

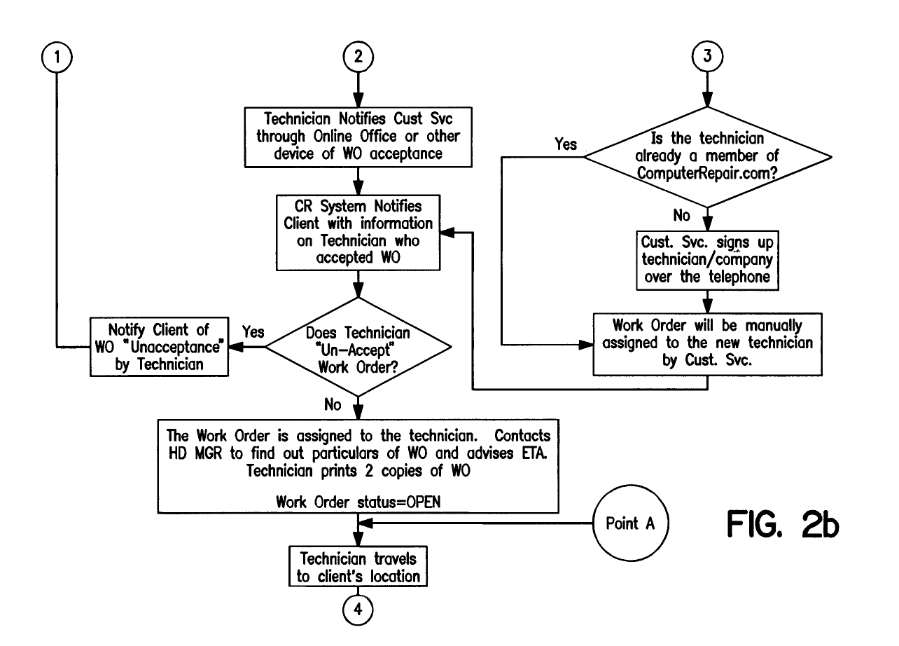

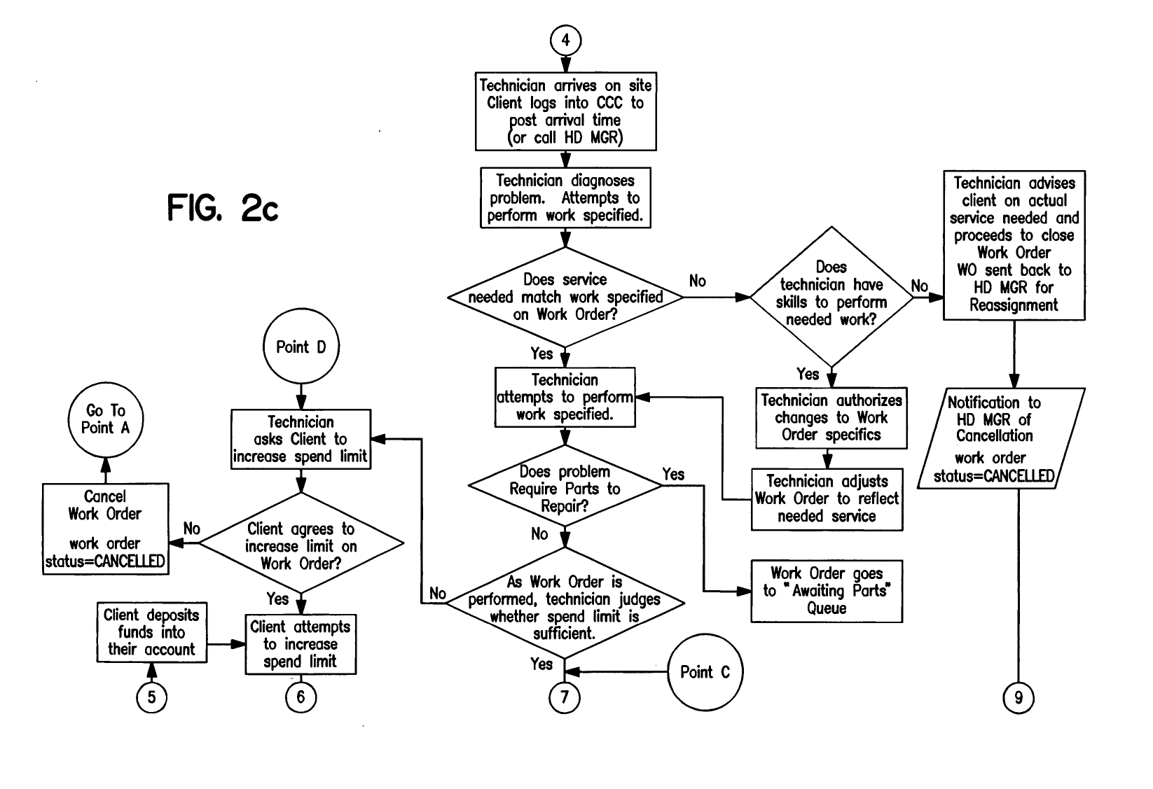

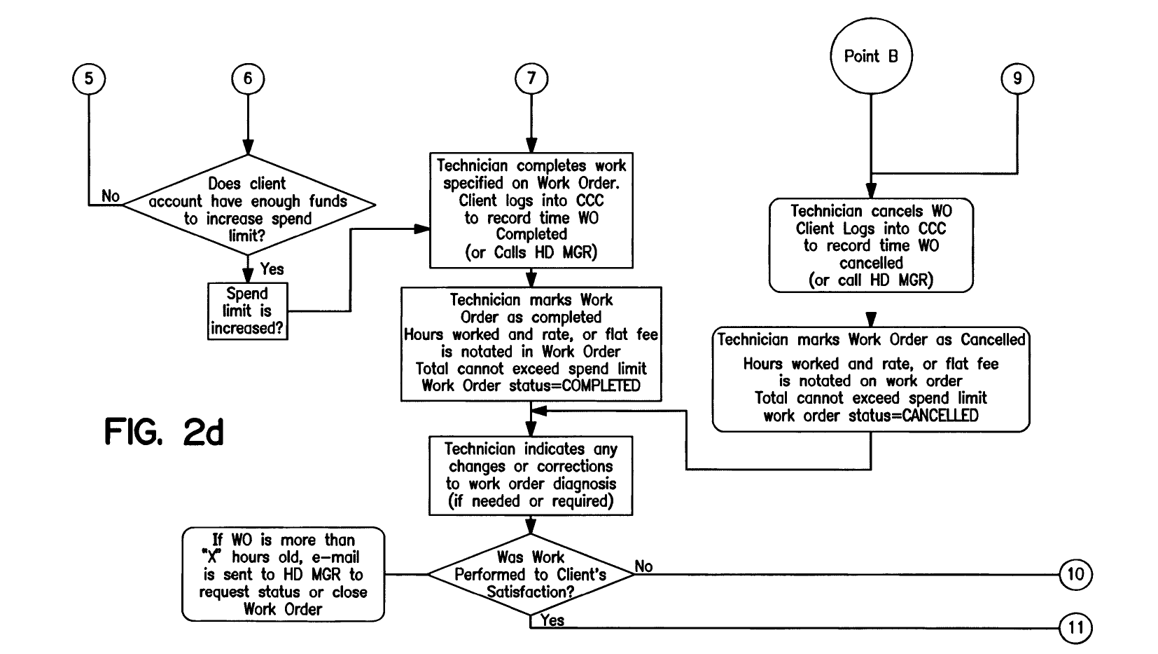

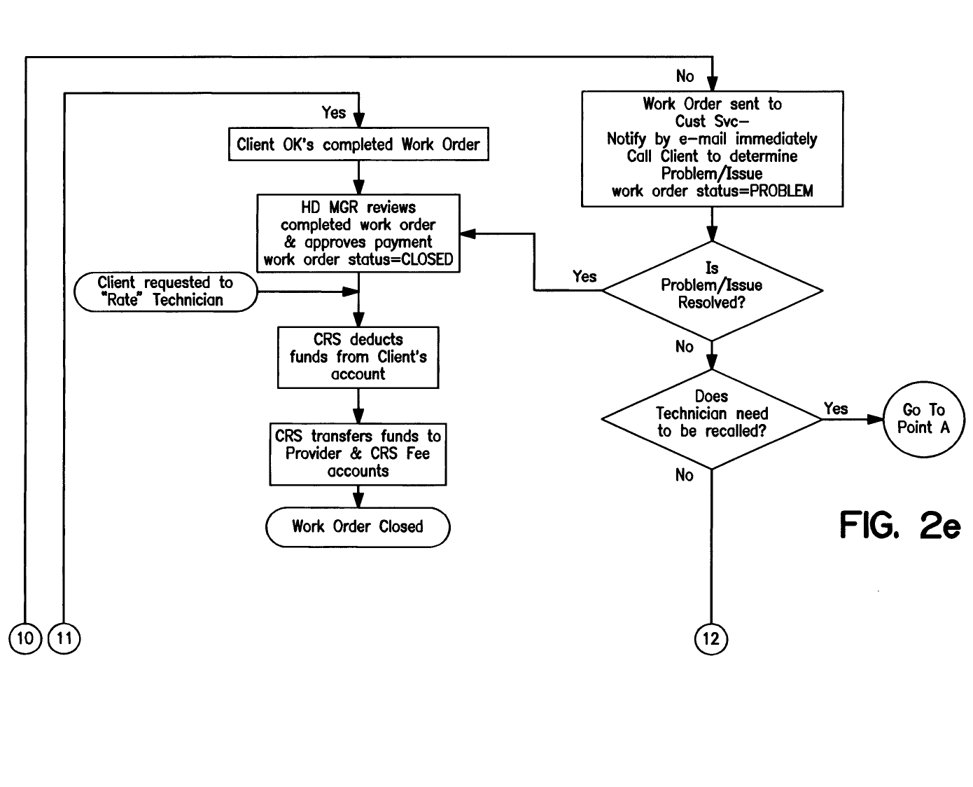

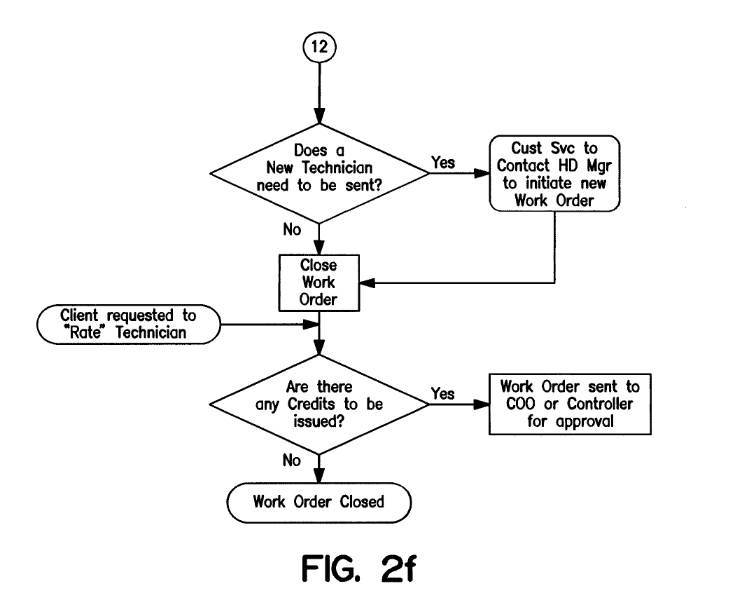

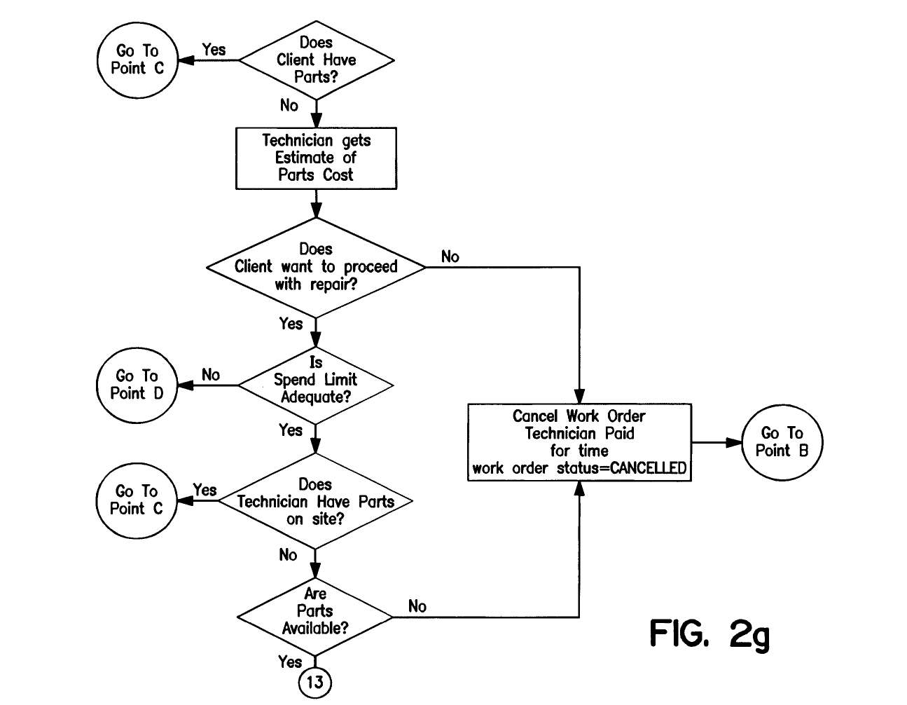

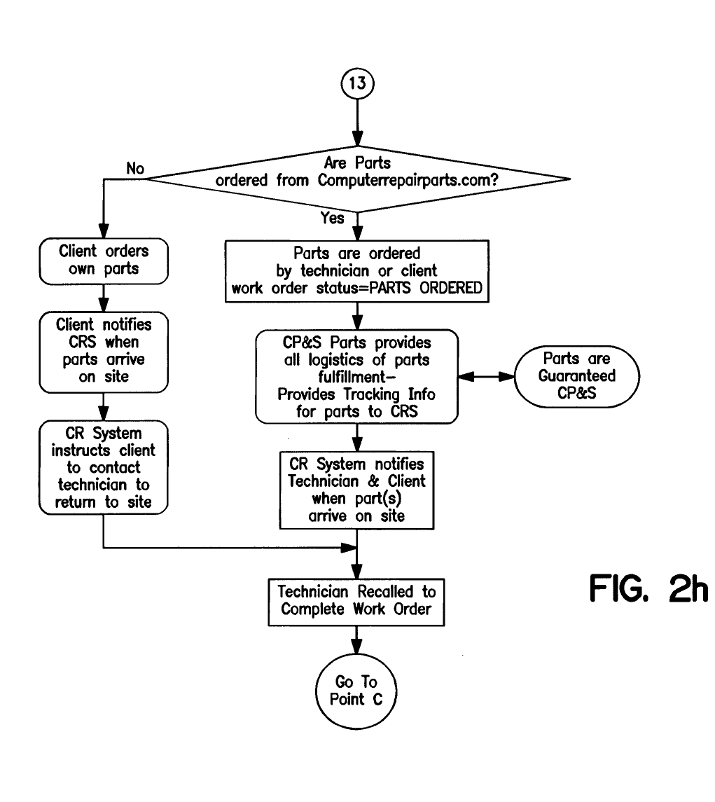

A network system in which the subject system and method may reside is illustrated by way of example in FIG. 1. In the illustrated network system, a Command Center 20, illustrated in the exemplary form of a computer system, is provided to manage service requests in a manner that will be described in greater detail hereinafter. While described and illustrated as a single computer system, it is again emphasized that the Command Center 20 may be implemented such that tasks are performed by various processing devices that are linked through a communication network such as the Internet, LAN, or the like.

For performing the various tasks, the Command Center 20 preferably includes a processing unit 22 and a system memory 24 which may be linked via a bus 26. Without limitation, the bus 26 may be a memory bus, a peripheral bus, and/or a local bus using any of a variety of bus architectures. By way of further example, the bus 26 may include an architecture having a North Bridge and a South Bridge where the North Bridge acts as the connection point for the processing unit 22, memory 24, and the South Bridge. The North Bridge functions to route traffic from these interfaces, and arbitrates and controls access to the memory subsystem from the processing unit 22 and I/O devices. The South Bridge, in its simplest form, integrates various I/O controllers, provides interfaces to peripheral devices and buses, and transfers data to/from the North bridge through either a PCI bus connection in older designs, or a proprietary interconnect in newer chipsets.

As needed for any particular purpose, the system memory 24 may include read only memory (ROM) 28 and/or random access memory (RAM) 30. Additional memory devices may also be made accessible to the Command Center 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the Command Center 20. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nonodrives, memory sticks, and other read/write and/or read-only memories.

A number of program modules may be stored in one or more of the memory/media devices. For example, a basic input/output system (BIOS) 44, containing the basic routines that help to transfer information between elements within the Command Center 20, such as during start-up, may be stored in ROM 24. Similarly, the RAM 30 and/or the hard drive 38 may be used to store computer executable instructions comprising an operating system 46, one or more applications programs 48, other program modules 50, and/or program data 52.

A user may enter commands and information into the Command Center 20 through input devices such as a keyboard 54 and/or a pointing device 56. While not illustrated, other input devices may include a microphone, a joystick, a game pad, a scanner, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the Command Center 20, a monitor 60 or other type of display device may also be connected to the bus 26 via an interface, such as video adapter 62. In addition to the monitor 60, the Command Center 20 may also include other peripheral output devices, not shown, such as speakers and printers.

For operating in a networked environment, such as the Internet, the Command Center 20 utilizes logical connections to one or more remote processing devices, such as client computer 64, technician computer 66, database computer 68, and/or financial institution computer 70. In this regard, while the remote processing devices have been illustrated in the exemplary form of computers, it will be appreciated that the remote processing devices may be any type of device having processing capabilities and/or the ability to establish a communication link with the Command Center 20 such as, for example, a cellular telephone. Again, the illustrated processing devices need not be implemented as a single device but may be implemented in a manner such that the tasks performed by the various processing devices are distributed to a plurality of processing devices linked through a communication network. Thus, the remote processing devices may include many or all of the elements described above relative to the Command Center 20 including the memory storage devices and a display device. The connection between the Command Center 20 and the remote processing devices is typically made through a further processing device 72 that is responsible for network routing. Furthermore, within such a networked environment, it will be appreciated that program modules depicted relative to the Command Center 20, or portions thereof, may be stored in the memory storage devices of the remote devices. It will also be understood that interface devices may also be used to establish links with devices lacking processing power, for example, an interactive voice response (“IVR”) system may be used to allow a conventional telephone to be interfaced with the Command Center 20.

To manage service requests, acts and symbolic representations of operations will be performed by the processing devices illustrated in FIG. 1. As such, it will be understood that such acts and operations, which are at times referred to as being computer-executed, include the manipulation by the processing devices of electrical signals representing data in a structured form. This manipulation transforms the data or maintains it at locations in the memory system, which reconfigures or otherwise alters the operation of the processing devices 20, 64, 66, 68, and 70 in a manner well understood by those of skill in the art of computer systems. The data structures where data is maintained are physical locations of the memory that have particular properties defined by the format of the data. Nevertheless, while described in the foregoing context, this description is not meant to be limiting as those skilled in the art will further appreciate that various acts and operations described herein may also be implemented in hardware.

By way of further example, the subject system and method may be implemented using a tiered architecture where one tier includes a front-end data base and Web applications running on Web server(s) that constitute an interface between users and the back-end of the system. In this manner, authorized users may access the system through a Web browser having a graphical user interface, for example, provided by a Java applet or as a common HTML page. To secure the system, the Web application may be surrounded by a firewall. The application logic would then constitute a further tier and may reside on a cluster of application servers including all of the capabilities necessary to support multiple transactions simultaneously.

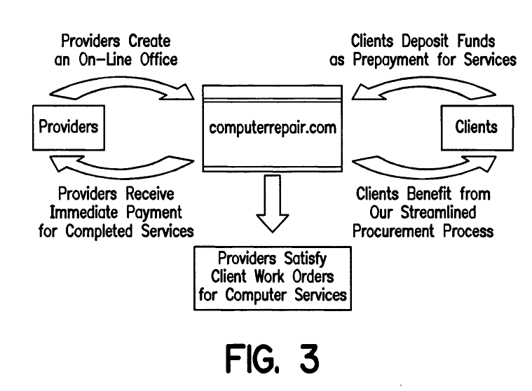

For use in controlling, building, and deploying a scalable workforce to solve service related problems, the Command Center 20 is used to provide an essentially automated system to link service requesters, e.g., corporate help-desk managers, with service providers, e.g., computer repair technicians. To this end, the Command Center 20 operates to provide a networked supply chain management system by which a service requestor may choose, for example via the Internet, one or more service providers, monitor the work performed by the service provider, and remit payment to the service provider(s) as generally illustrated in FIG. 3. It is also contemplated that the operator of the Command Center 20 would receive a fee on each transaction from one or both of the service provider (e.g., a percentage of invoice amount) and the service requestor (e.g., a flat fee). It is also contemplated that the operator of the Command Center 20 may provide fee services to companies whereby the operator of the Command Center 20 essentially functions as a centralized help desk and arranges for service providers to meet the needs of service requesters.

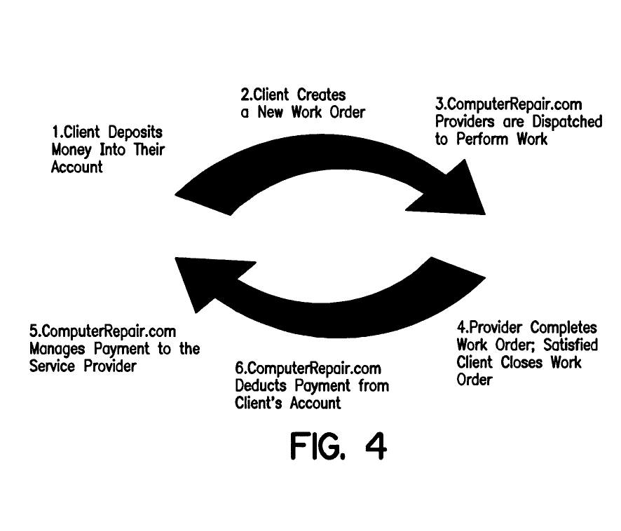

For a service requestor to become a system client, the service requestor preferably registers with system, for example, by accessing a Web site maintained by the Command Center 20 using client computer 64 and by providing information requested by the Command Center 20. This information may include, but need not be limited to, preferred fees, geographic locations, preferred service providers, preferred hours of availability, preferred certifications, identification of employees that are authorized access, etc. As generally illustrated in FIG. 4, the operator of the Command Center 20 may also require service requester clients to deposits funds into an account accessible by the Command Center 20 for reasons that are described in further detail hereinafter. Management of deposit account funds may be performed directly by the Command Center 20 or the Command Center 20 may interact with one or more financial institution computers 70 for this same purpose as described, for example, in U.S. patent application Ser. No. 10/692,181, entitled “System And Method For Managing Accounts Payable,” which is hereby incorporated by reference in its entirety. Among other things, the registration of the service requestor as a client of the system addresses a need for companies to have a single point of contact and solves the problem of payments to, and management of, multiple vendors. Registration information may be stored and accessed by the Command Center 20 directly or by means of cooperation with a database server computer 68.

Once a service requestor client has registered with the system, service requestor clients will be able to link to the Command Center 20 to perform tasks such as, for example, updating and/or changing registration information, forming a web page, generating a service request, precisely identifying service personnel that the service requestor client desires to meet their service request, managing and following up on service requests, paying the service providers (e.g., requesting a withdraw against their deposit), negotiating service contracts, and/or providing feedback on each service provider. In this regard, service requestor clients may access the Command Center 20 by means of the Internet, e.g., by accessing a Web site page maintained by the Command Center 20, and/or through the use of APIs that function to directly interface client computer 64 with the Command Center 20.

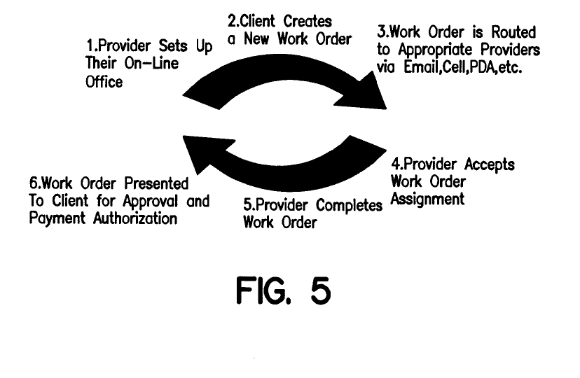

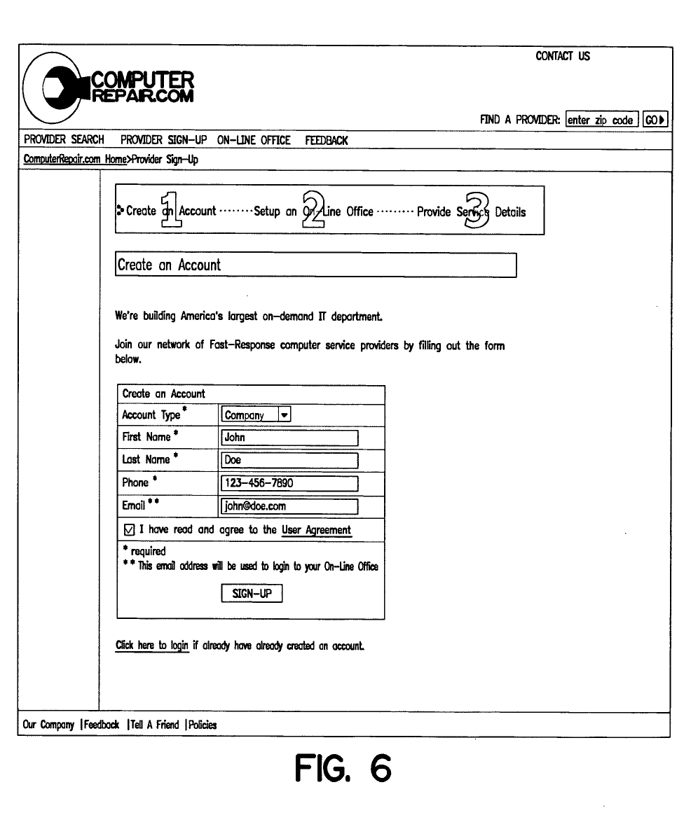

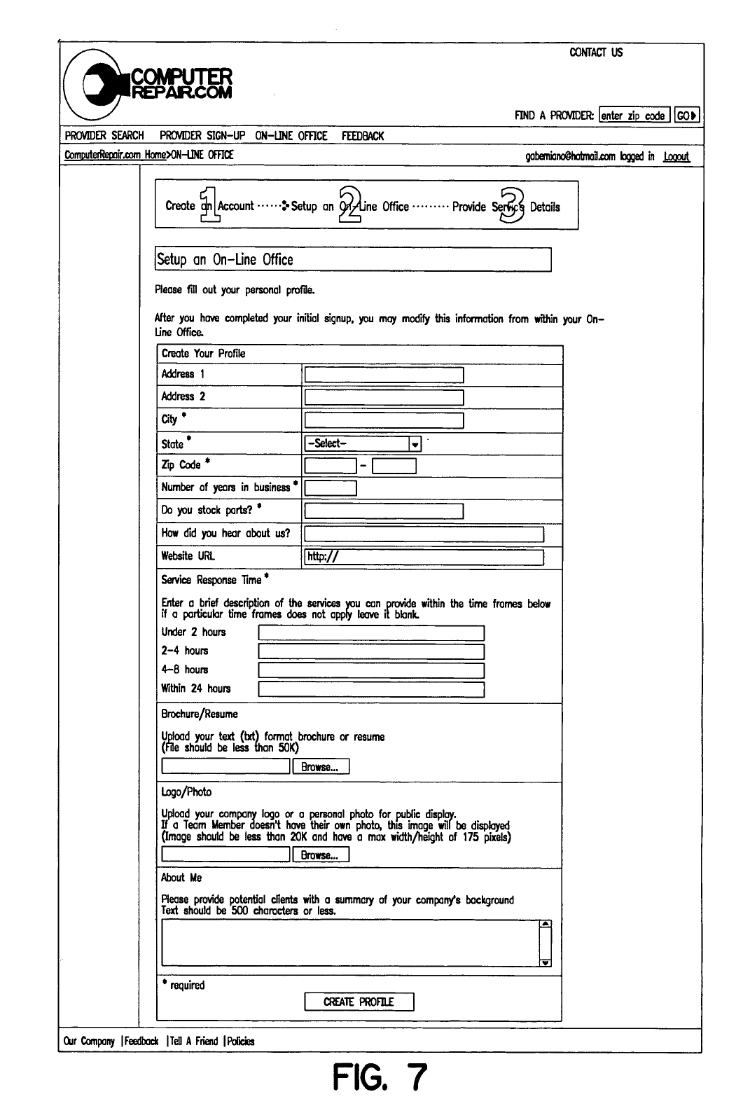

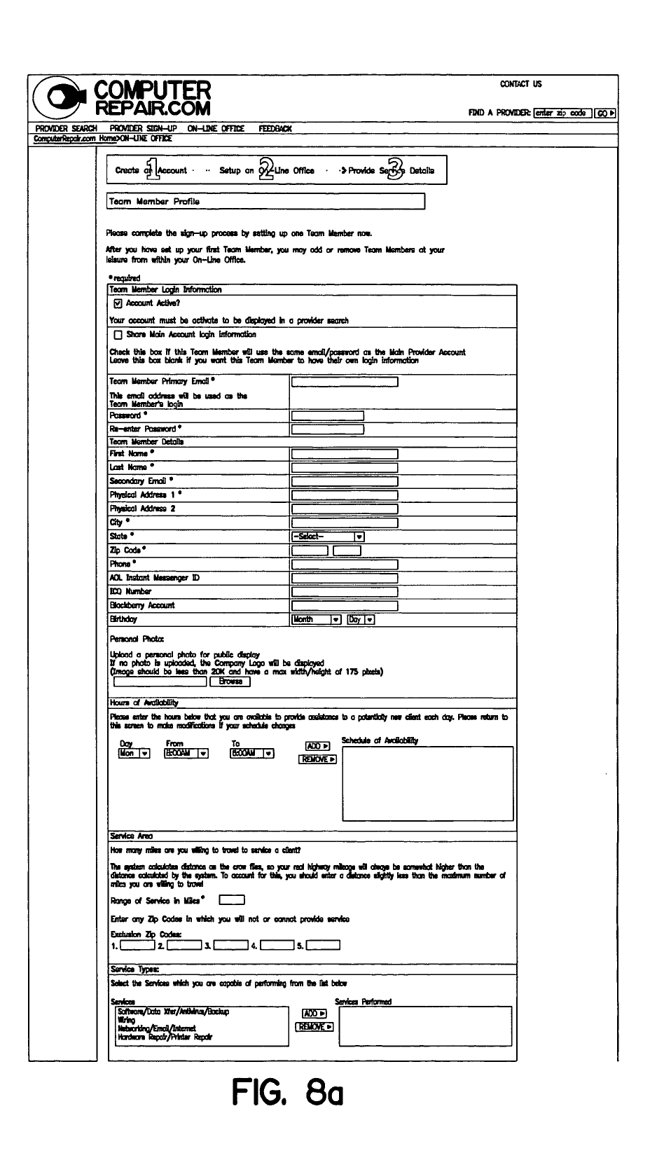

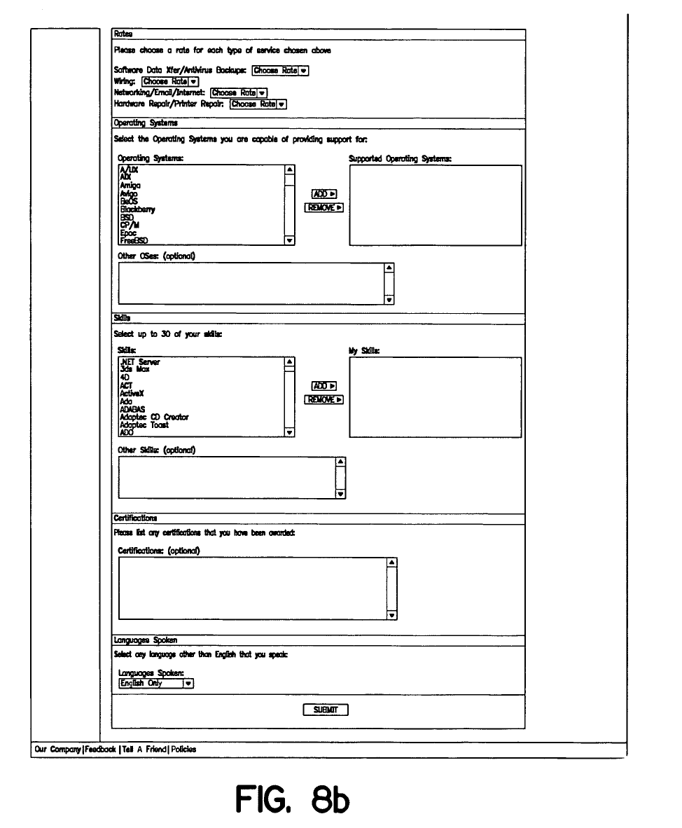

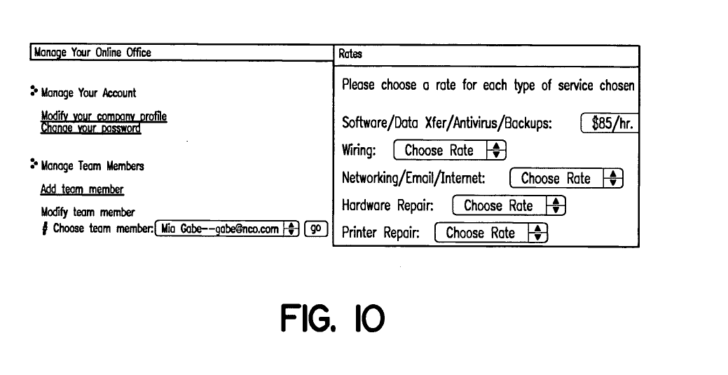

For a service provider to become a client of the system, as illustrated in FIG. 5, the service provider also preferably registers with the system, for example, by accessing a Web site maintained by the Command Center 20 using technician computer 66 and by providing information requested by the Command Center 20. In this regard, as illustrated by way of example in FIGS. 6-8, the service provider may be requested to provide information to create an account with the Command Center 20 as well as information that will become available via an on-line office to potential service requestors. To these ends, the Command Center 20 may collect information concerning a client service provider company and/or information concerning individual employees of the client service provider. Thus, information collected during the registration process may include contact information for the company and/or individuals, employee skill sets, geographical locations for service areas, availability times, rates, response times, certifications, languages spoken, etc., as is particularly illustrated in FIGS. 6-8. FIG. 10 further illustrates a screen shot of an exemplary page whereby a service provider may manage their on-line office, e.g., to modify a company profile, add team members, change contact information, etc. In this manner, the system provides intuitive on-line tools for marketing each provider and managing workflow.

As noted, once such registration information has been collected, a service provider client will have the equivalent of an on-line office with the Command Center 20 which is accessible by service requestor clients. While information concerning a registered service provider client may also be viewable by the general public, i.e., a non-registered service requestor, such information is preferably limited to prevent a viewer from contacting the service provider outside of the system, e.g., contact information may be prevented from being displayed. Access to the on-line office can be made directly via the Command Center 20 and/or by the service provider client causing URLs relating to the service provider client to be redirected to their on-line office as maintained by the Command Center 20. Again, the on-line office preferably contains information that would be viewable by potential service requesters such that a potential service requestor can discern if a particular client service provider is appropriate for a given service need.

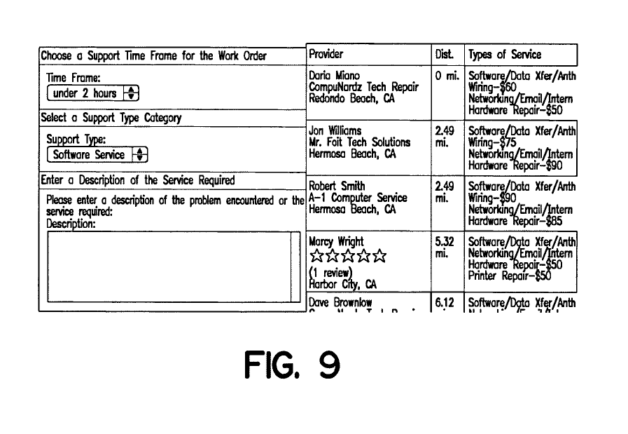

For requesting services, a client service requester may contact the system for the purpose of creating a work order. For example, this may be performed by a service requestor supplying information to the Command Center 20. In this regard, the Command Center 20 may be contacted via any means such as, for example, accessing the Command Center 20 Web site via a processing device (e.g., client computer 64) contacting Command Center 20 personnel via telephone, PDA, facsimile machine, e-mail, paging network, radio telephone, or the like. In these latter instances, the Command Center 20 personnel may be required to then manually enter the service request information into the Command Center 20 for the purpose of allowing the Command Center 20 to create a work order. An exemplary screen for creating a work order is illustrated by way of example in FIG. 9.

In response to the creation of a work order, the Command Center 20 may cause a fee to be deducted from the account of the client service requestor, for example, as a pre-paid retainer or transaction service fee. The fee may be deducted immediately or at some future time, such as upon completion of the service request. At this time, the created work order may also be routed by the Command Center 20 to one or more client service providers. In this regard, a client service requestor may specify one or more intended recipients of the work order. To this end, client service requesters may be provided with the ability to search the existing database of client service providers. Alternatively, the Command Center 20 may identify one or more client service providers for the work order based upon information contained in the work order or otherwise specified by the client service requestor. Information utilized to route work orders in this manner may include a desired or required skill set, hourly rate, availability, geographic location, response time, range or experience, certifications, spend limit, and/or client service provider rating. It will also be appreciated that the information utilized to route work orders may be pre-established by a client service requestor, for example during the registration process, or it may be supplied in connection with the request for services.

To direct work orders to intended recipients, the Command Center 20 may cause work orders to be transmitted to one or more of a technician computer 66, telephone, PDA, facsimile machine, e-mail account, pager, etc. of a client service provider. The recipient client service providers may then respond to the Command Center 20 to indicate a desire to answer the service request. Preferably, the client service provider that is first to respond to the Command Center 20 and which is qualified to perform work associated with the service request is awarded the service request contract. Prior to and/or after the assigning of a service request, a client service requestor may access the Command Center 20 to monitor all service logistics in real-time. For this purpose, any received service requests and/or work orders may be assigned a look-up number which would be transmitted to the service requestor. The service requestor may then indicate the look-up number to access status information maintained by the Command Center 20.

When the service request that is the subject of the work order is completed by the client service provider, information concerning the completed service request is provided by the client service provider to the Command Center 20 using any of the communication methodologies described previously. The Command Center 20 may then issue a notification to the client service requestor which notification would contain information relevant to the completion of the service request/work order. Again, the service request/work order completion notification may be issued to the client service requestor by being transmitted to one or more of a client computer 64, telephone, PDA, facsimile machine, e-mail account, pager, etc. of the client service requestor.

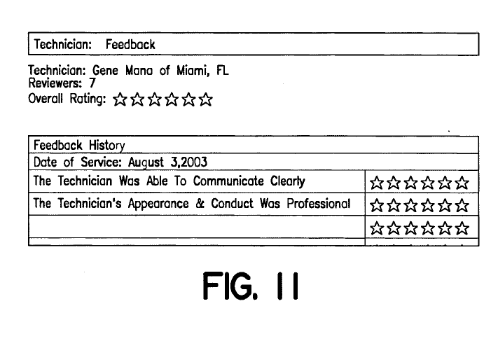

The client service requestor may transmit a response to the Command Center 20 to confirm the completion of the service request and the satisfaction of the client service requestor with respect to the work performed. At this time, the client service requestor may also authorize the Command Center 20 to convert the work order to an invoice so as to allow the Command Center 20 to access the account of the client service requestor for the purpose of issuing payment to the client service provider. In this regard, payment may be made electronically to an account of the client service provider, as described in U.S. patent application Ser. No. 10/692,181, entitled “System And Method For Managing Accounts Payable,” by alternative means such as the issuance of a check or the like. A client service requestor may additionally access the Command Center 20 to complete a survey regarding the completion of the service request/work order by the client service provider. Information collected in such a survey may then be used to establish a rating for the client service provider for use in the future assignments of work orders, for example by providing an overall rating and ratings for one or more skill sets, punctuality, professionalism, etc. as illustrated in FIG. 11.

In instances where the service provider is unable to complete the work order, for example, if a particular part must be replaced that needs to be specially ordered, the system may allow for the service provider to request that the work order be renegotiated with the service requestor for the purpose of addressing these additional needs. This negotiation may be done via message exchanges through the system or done directly between the parties. In either case, the system should be notified as to any changes or alterations to the work order so as to allow for the updating of the work order to ensure proper accounting. It is also contemplated that, in this case, the parties may agree that the work order is completed for purposes of accounting only and that the service requestor will issue a further service request for the purpose of having the work completed in actuality.

From the foregoing, it will be appreciated that the subject system and method has, among others, the advantages of: providing customers with a single point of contact, responsibility, and billing. It also has the advantage of providing a convenient means, e.g., the Internet, for accessing services. In the context of corporate customers, the system allows these customers to electronically control and monitor the service process; to choose service provider(s) in various regions—by certifications (e.g., by Dell, Compaq, Microsoft, etc.), by range of fees, by range of experience, etc., to insure proper and timely services throughout the United States, etc. The subject system and method also has the advantage of providing service requesters with a generic catalog of services, possibly at substantially reduced prices. Still further, the subject system and method may allow access to certain providers of parts and/or providers of additional services that may be required.

With respect to the service providers, the subject system and method has, among others, the advantage of providing for a steady flow of work (i.e., in the form of work orders) whereby service provider personnel will be able to better manage their daily schedules, receive payments and earn more consistent pay while providing faster response times to end users.

While various concepts have been described in detail, it will be appreciated by those skilled in the art that various modifications and alternatives to those concepts could be developed in light of the overall teachings of the disclosure. For example, it is contemplated that service requesters and service providers may use information contained with the subject system to interact directly. Once service requesters and service providers are connected in this manner, the remaining functionality of this system will still be utilized so as to maintain centralized management of the service and payment process. Furthermore, while generally described in the context of managing computer related services, it will be appreciated that the concepts described herein may be used to manage provision of any type of services. By way of example only, the subject system and method may be used to manage the placement of temporary employees, to manage the placement of nurses, etc. where the work order would request the services of the temporary employee, nurse, etc. (e.g., specifying a location, particular need, time, and the like. As such, the particular concepts disclosed are meant to be illustrative only and not limiting as to the scope of the invention which is to be given the full breadth of the appended claims and any equivalents thereof.

What is claimed is:

1. A readable-media for use in connection with a processing system having instructions for managing service requests, the instructions performing steps comprising:
populating a registry with a plurality of service providers;
creating a work order from a request for services received from a service requestor where the work order is to be routed to one or more service providers selected from the registry for the purpose of having one or more of the selected service providers indicate an acceptance of the work order; and
causing payment to be made to a selected service provider that indicated an acceptance of the work order, which was then assigned the work order, and which completed at least a portion of the work order using a fund associated with the service requester.

2. The readable-media as recited in claim 1, further comprising instructions for registering the service requestor and establishing the fund associated with the service requester.

3. The readable-media as recited in claim 1, wherein populating the registry further comprises creating an on-line office for each of the plurality of service providers, the on-line office having information that describes capabilities of the service provider and being accessible via a network connection with the processing system.

4. The readable-media as recited in claim 1, wherein the request for services is received via a network connection with the processing system.

5. The readable-media as recited in claim 1, wherein the request for services is received by being manually entered into the processing system.

6. The readable-media as recited in claim 1, further comprising instructions for routing the work order to one or more service providers selected from the registry via a network connection with the processing system.

7. The readable-media as recited in claim 1, wherein the one or more service providers are selected from the registry by the service requestor.

8. The readable-media as recited in claim 1, wherein the one or more service providers are selected from the registry by comparing capabilities of the service providers and information contained in the service request.

9. The readable-media as recited in claim 8, wherein the capabilities of the service providers and information contained in the service request that are compared relate to geographic locations.

10. The readable-media as recited in claim 8, wherein the capabilities of the service providers and information contained in the service request that are compared relate to times of availability.

11. The readable-media as recited in claim 8, wherein the capabilities of the services providers and information contained in the service request that are compared related to familiarity with equipment associated with the service.

12. The readable-media as recited in claim 1, further comprising instructions for accepting feedback from the service requestor to establish a rating for the one or more of the selected service providers that were assigned the work order.

13. The readable-media as recited in claim 1, further comprising instructions for assigning the work order to the selected service provider that is first to respond to the routed work order.

14. The readable-media as recited in claim 1, further comprising instructions for maintaining status information concerning the assigned work order which status information is accessible by the service requestor.

15. A method for managing service requests, comprising:
accepting information provided via a network connection from a plurality of service providers, the information being representative of capabilities and availabilities of each of the service providers creating a registry comprising the information provided by each of the plurality of service providers;
creating a work order from a request for services received from a service requestor;
routing the work order to one or more service providers selected from the registry for the purpose of having one or more of the selected service providers indicate an acceptance of the work order; and
causing payment to be made to a selected service provider that indicated an acceptance of the work order, which was then assigned the work order, and which completed at least a portion of the work order using a fund associated with the service requestor.

16. The method as recited in claim 15, further comprising instructions for registering the service requestor and establishing the fund associated with the service requestor.

17. The method as recited in claim 15, wherein populating the registry further comprises creating an on-line office for each of the plurality of service providers, the on-line office having the information for the service provider and being accessible via a network connection for review by the service requestor.

18. The method as recited in claim 15, wherein the request for services is received via a network connection.

19. The method as recited in claim 15, further comprising routing the work order to one or more service providers selected from the registry via a network connection.

20. The method as recited in claim 15, further comprising routing the work order to one or more service providers selected from the registry via a facsimile machine.

21. The method as recited in claim 15, further comprising routing the work order to one or more service providers selected from the registry via a telephone.

22. The method as recited in claim 15, wherein the one or more service providers are selected from the registry by the service requestor.

23. The method as recited in claim 15, wherein the one or more service providers are selected from the registry by comparing the information of the service providers and information contained in the service request.

24. The method as recited in claim 23, wherein the information compared relates to geographic locations.

25. The method as recited in claim 23, wherein the information compared relates to times of availability.

26. The method as recited in claim 23, wherein the information compared relates to equipment associated with the service requested.

27. The method as recited in claim 15, further comprising accepting feedback from the service requestor to establish a rating for the one or more of the selected service providers that were assigned the work order.

28. The method as recited in claim 15, further comprising assigning the work order to the selected service provider that is first to respond to the routed work order.

29. The method as recited in claim 15, further comprising maintaining status information concerning the assigned work order which status information is accessible by the service requestor.
